(19) United States
(12) Patent Application Publication
(10) Pub. No.: US 2007/0205290 A1
(43) Pub. Date: Sep. 6, 2007

(54) PRESENTATION AND TRANSACTION INSTRUMENTS WITH IMAGE DISPLAY

(75) Inventors: Keith Newbrough, Parker, CO (US); Ken Algiene, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/682,174

(22) Filed: Mar. 5, 2007

Related U.S. Application Data
(60) Provisional application No. 60/779,911, filed on Mar. 6, 2006.

(51) Int. Cl. G06K 19/00; G06K 19/06

(52) U.S. Cl. 235/487; 235/492

(57) ABSTRACT

The present invention generally relates to presentation and transaction cards with graphic image display, which may generally be dynamically modified or personalized following manufacture of the presentation or transaction card body. By way of example, the graphic images may be, e.g., digital image or photo files that may be electronically displayed on a surface of the presentation or transaction instrument for, e.g., promotional, advertising, security, and/or entertainment purposes. Methods for modifying or personalizing the appearance of a presentation or transaction instrument of the invention are also provided.

### CROSS REFERENCES TO RELATED APPLICATIONS

This application in a continuation in part application and claims the benefit of U.S. Provisional Patent Application No. 60/779,911, filed Mar. 6, 2006, the complete disclosure of which is herein incorporated by reference.

### BACKGROUND OF THE INVENTION

This application relates generally to presentation and transaction instruments.

Presentation and transaction cards and the use of such instruments to access, e.g., financial or stored value accounts is well known. Examples of such presentation or transactions instruments include credit cards, debit cards, ATM cards, phone cards, stored value cards, and the like. Presentation cards are also known to provide advertising, display, or informational purposes.

When used in financial or transactional matters, such instruments typically contain an account number in some form or another that permits the card holder to gain access to their account, such as when making a purchase. One common way to store the account information is through the use of a magnetic stripe that extends lengthwise along the card. To read the card, a point of sale device, such as the one described in U.S. application Ser. No. 10/116,689, filed Apr. 3, 2002, incorporated herein by reference, may be used. The account identifier that is read from the card may then be electronically transmitted to a processing system in order to complete the transaction. Another way to store the account information is by using a bar code that is read using a bar code reader. Other forms of storage devices include smart chips, RFID tags, MICR lines, and the like.

In addition to account information, presentation and transaction cards often include promotional, advertising, identification, or decorative display information and/or images. However, currently, the appearance of presentation and transaction cards is generally fixed and static upon manufacture.

It is desirable to develop presentation and transaction cards with dynamic display capabilities, which may be interactive or may be modified post-manufacture.

### BRIEF SUMMARY OF THE INVENTION

To address these and other needs, the present invention provides presentation and transaction cards with dynamic display capabilities.

Thus, in one aspect of the invention, a presentation or transaction instrument with graphic image display is provided. The presentation or transaction instrument generally comprises a presentation or transaction card body, at least one graphic image display element, and display update mechanism. In certain embodiments, the presentation or transaction card body will define a front surface and a back surface, with the card body having long term information printed on at least one surface thereof. The graphic image display element(s) are generally configured to display at least one graphic image file, viewable from at least one side of the presentation or transaction card body. Further, the display update mechanism is generally configured to receive input of a graphic image file from an external file source and to interface with the graphic image display element(s) to provide the graphic image file thereto, to thereby provide for display of the graphic image file.

In certain embodiments, the graphic image display element(s) may comprise an electro-optic display, such as a flexible LCD screen, a light emitting polymer (LEP) display, LED display, and electronic paper. The electro-optic display may also have an image memory function that does not require power to maintain temporary display of the graphic image file(s) once implement in the image memory function.

In another aspect of the invention, a method of personalizing the visual appearance of a presentation or transaction instrument is provided. Such methods of the invention generally comprise: providing a presentation or transaction instrument with graphic image display capability, as described herein; interfacing with the display update mechanism; and inputting at least one personalized graphic image file via said display update mechanism for display via the graphic image display element(s), thereby personalizing the visual appearance of the presentation or transaction instrument.

In certain embodiments, the graphic image file is inputted from an external file source, such as a digital camera, a database, or a personal computer. Further, in certain embodiments, the graphic image file is a digital photo.

These and other aspects will become apparent to one of skill in the art upon reading the disclosure.

### BRIEF DESCRIPTION OF THE DRAWINGS

FIGS. 1A and 1B illustrate exemplary embodiments of the presentation or transactions cards of the present invention.

FIG. 2 illustrates an exemplary method of the invention.

### DETAILED DESCRIPTION OF THE INVENTION

The present invention generally relates to presentation and transaction cards with graphic image display, which may generally be dynamically modified or personalized following manufacture of the presentation or transaction card body. By way of example, the graphic images may be, e.g., digital image or photo files that may be electronically displayed on a surface of the presentation or transaction instrument for, e.g., promotional, advertising, security, and/or entertainment purposes.

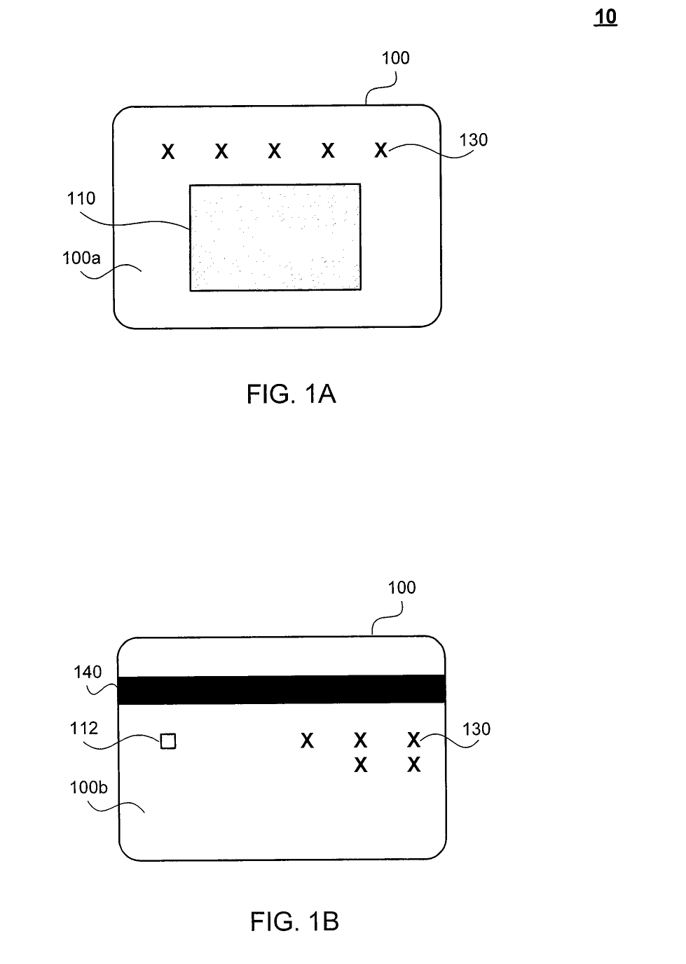

By way of example, with reference to FIGS. 1A and 1B, the presentation or transaction instruments 10 of the invention will generally include a presentation or transaction card body 100 defining a front surface 100a (FIG. 1A) and a back surface 100b (FIG. 1B), as generally recognized by those skilled in the art. The presentation or transaction card 10 may be any known type of presentation or transaction card, such as stored-value cards, credit cards, automated teller machine cards, calling cards, transit cards, business cards, promotional cards, etc. However, the invention is not limited to the particular use of the presentation or transaction card. Further, the card body may be sized and shaped in any manner suitable for the intended use. For example, the card body may have the shape, size and thickness of a traditional CR 80 card. Other examples include “mini cards”, key fobs of various shapes and sizes, and the like. Further, in some cases, at least a portion of the card body may have a thickness small enough to permit it to be swiped through a traditional POS device.

In certain embodiments, the card body 100 will be configured to include a magnetic strip 140 or other machine readable information (not shown) such as an embedded memory chip with exposed contacts on the card body, other chip based member devices, key fobs, an RFID chip embedded in the card body, bar code information printed on the card body, or combinations thereof. In such embodiments, it may be preferable to utilize standard configurations for the machine readable components so as to aid in compatibility with, e.g., point of sale devices, chip readers, bar code readers, etc. For example, with mag strip based cards, the portion of the card body having the magnetic stripe will have a thickness which permits it to be swiped through a card reader of a POS device. However, other portions of the card body, such as the portion having the display, may be thicker in order to accommodate the appropriate materials/electronics.

For instance, it may be desirable for the machine readable components to be sized and shaped to as to be adaptable for use in connection with standard point-of-sale device. Examples of suitable POS devices are provided in the following commonly assigned applications, the entire disclosures of which are incorporated herein by reference for all purposes: U.S. Prov. Pat. Appl. No. 60/147,889, entitled “Integrated Point Of Sale Device,” filed Aug. 9, 1999 by Randy J. Templeton et al.; U.S. patent application Ser. No. 09/634,901, entitled “Point Of Sale Payment System,” filed Aug. 9, 2000 by Randy J. Templeton et al.; U.S. patent application Ser. No. 10/116,689, entitled “Systems And Methods For Performing Transactions At A Point-Of-Sale,” filed Apr. 3, 2002 by Eamey Stoutenburg et al.; U.S. patent application Ser. No. 10/116,733, entitled “Systems And Methods For Deploying A Point-Of-Sale System,” filed Apr. 3, 2002 by Earney Stoutenburg et al.; U.S. patent application Ser. No. 10/116,686, entitled “Systems And Methods For Utilizing A Point-Of-Sale System,” filed Apr. 3, 2002 by Earney Stoutenburg et al.; and U.S. patent application Ser. No. 10/116,735, entitled “Systems And Methods For Configuring A Point-Of-Sale System,” filed Apr. 3, 2002 by Earney Stoutenburg.

In certain embodiments, the card body 100 may also include long term information 130 printed or displayed on at least one surface thereof, which is not dynamically modifiable following production of the presentation or transaction card body. Such information 130 may include identification information, account information, promotional information, advertising information, security information, instructions for inputting graphic image files, etc.

More particularly, in certain embodiments, the presentation or transaction cards 10 of the invention may generally comprise some form of identifier, which may be sufficient to uniquely identify the card. Merely by way of example, a card may comprise a magnetic stripe and/or a bar code. The card identifier, which might be a serial number and/or other string of text and/or numbers, then, might be encoded onto the magnetic stripe and/or represented by the bar code. Those skilled in the art will appreciate the variety of methods that can be used to encode/decode a magnetic stripe and/or translate a bar code. Further, those skilled in the art will appreciate that there are a number of ways known in the art to store information associated with a presentation or transaction card, and any of them may be used as appropriate to store the first and/or second identifiers. Merely by way of example, in some embodiments, the first and/or second identifier may be stored in various ways (such as RFID tag or chips embedded in the card, holograms, etc.) and/or any appropriate scanner, RFID reader and/or hardware may be used to obtain and/or input the first and/or second identifier. Bar codes, track data, account information, etc. may also be printed on the card, as known in the art.

In some cases, the presentation or transaction cards may comprise both a magnetic stripe and a bar code and/or RFID chip. The magnetic stripe may be used to store a first identifier (such as an account number associated with the instrument and/or the like), which may also be printed, embossed, etc. on the instrument. The bar code may represent a second identifier, which may have some relation to the first identifier, or may incorporate a personal account number, a personal identification number, etc. Merely by way of example, in some cases, the bar code may be a Code 128 bar code known in the art. As recognized by those skilled in the art, the identifier may also be encrypted. The encrypted value representing the identifier can be derived using any appropriate technique, of which many are known in the art. An exemplary technique may comprise 3DES encryption. As used herein, a stored-value instrument identifier can be any single identifier or combination of identifiers, such as a first identifier, second identifier, etc., or any combination thereof.

The presentation and transaction cards 10 of the present invention further include at least one graphic image display element 110. The graphic image display element(s) 110 are generally configured to display one or more graphic images, such as a digital image or photo file including one or more images, on at least one side of the card body. The graphic images may be in the form of graphic image files. Such graphic image files may be in any suitable file format known in the art, including but not limited to JPEG, TIFF, RAW, GIF, and DNG file formats.

The graphic image display element(s) 110 will display the graphic image file(s) in a “dynamic” manner, meaning that, e.g., the graphic image file(s) may be modified, changed, personalized, etc. for display on the presentation or transaction card following production of the card body. In this way, a presentation or transaction card of the invention may be produced including at least one graphic image display element, and one or more graphic image files may later be input for display. Further, if desired, the graphic image(s) so displayed may be modified as desired to dynamically change the appearance of the presentation or transaction card. One type of technology that may be used is that of a three dimensional hologram that visually projects out of the card body.

The graphic image display element(s) 110 may be sized and located along the card body in any suitable manner. In certain embodiments, the graphic image display element(s) may comprise the entire front and/or back surface of the card body, if desired. In other embodiments, the graphic image display element(s) may be sized and positioned along the card body surface(s) so as to provide unobstructed display of the graphic image file with suitable resolution and pixel size. In certain embodiments, the graphic image display element(s) are positioned, carried or supported on a surface of the presentation or transaction card body. The element(s) may be affixed to or integrated into the surface of the card body in any suitable manner known in the art, such as through the use of suitable fixatives or lamination techniques.

In this regard, the presentation and transaction cards 10 of the present invention also include a display update mechanism 112 configured to receive input of the graphic image file(s) for display of the graphic image(s). Generally, the graphic image file(s) may be input from an external file source. As shown, the display update mechanism 112 may be visibly located on the back surface 100b of the card body 100, or alternatively may be located on the front surface of the card body (not shown). In other embodiments, the display update mechanism may be integrated into the interior of the card body, and may not be visible on the surface of the card.

The display update mechanism 112 will interface with graphic image display element(s) 110 to provide the graphic image file(s) thereto, to thereby provide for display of graphic images via the graphic image display element(s). Any suitable interface known in the art for such purposes may be used. In certain embodiments, the display update mechanism is configured to receive input of graphic image files via a wired or wireless communications interface. Any suitable communications interface known in the art may be used, including cellular, Bluetooth, USB, etc. By way of example, the graphic image file source may be a digital camera, a database, a personal computer, etc., and the presentation or transaction card of the invention may interface with the file source via the display update mechanism. For instance, a portion of the card body could include a USB port adapted to permit a USB plug to be coupled to the card. In this way, files from cameras, computers, etc may be downloaded onto the card. In a similar manner, any digital content, such as music, text and the like could be downloaded. The card body could also include a speaker, such as a flat panel speaker, to permit the card body to play music or other audio content.

In accordance with the present invention, the at least one graphic image display element comprises an electro-optic display which is configured to dynamically display the graphic image file(s) on at least one surface of the presentation or transaction card body, as described above. In certain aspects, the electro-optic display comprises an image memory function that does not require power to maintain temporary display of the graphic image file once implement in the image memory function. In this manner, one the graphic image file(s) are input into the graphic image display element, the presentation or transaction card of the invention does not require power to maintain display of the graphic image file for a predetermined amount of time, e.g., for at least 1 month, at least 6 months, up to one year, until another graphic image file is input into the graphic image display element, etc.

Any suitable electro-optic display capable of displaying the graphic image file may be used, but in certain embodiments, the electro-optic display is selected from the group consisting of a flexible LCD screen, a light emitting polymer (LEP) display, and electronic paper, as generally known in the art. Examples of suitable electro-optic displays are described, e.g., in U.S. Patent Publication 2005/0122565 and the documents cited therein, which are herein incorporated by reference. In other embodiments, the electro-optic display may comprise a display screen, a fiber optic, and a projector mechanism, wherein the projector mechanism is configured to project the graphic image file to the fiber optic, and the fiber optic is interfaced with the display screen so as to project the graphic image onto the display screen for display of the graphic image file on the screen.

Other suitable electro-optic displays include electronic paper, such as those developed by E-Ink, Gyricon and Kent Graphics. Several approaches have been developed for potential applications of electronic paper including: thermochromism, electrochromic, electroluminescent polymers and magnetic particle systems. By way of example, E-Ink is a technology based on electrophoretics that uses microcapsules, ˜30-300 .μm in diameter, for encasing electrophoretic materials. These spheres are tightly packed between 2 plastic sheets. The spheres contain tiny white pigment chips, suspended in a blue-black liquid dye. Applying a field moves the particles, and the microcapsules can be switched into reflecting or absorbing mode by applying a positive or negative voltage across electrodes.

Gyricon is a product of Gyricon Media, a spin-off of Xerox located at the Palo Alto Research Center. Gyricon displays are made of millions of bichromal beads embedded between 2 plastic sheets by a flexible elastomeric matrix of oil filled cavities. The beads have contrasting hemispheres, white on one side (highly reflective) and black on other (absorbs light). The beads reside in their cavities, and on application of a voltage, they can present one or the other side to the viewer. An intermediate level switching voltage can produce gray-scale images. The plastic sheets can be produced in rolls like old fashioned paper while the balls are made by spraying molten wax-like plastics on opposite sides of a spinning disk. Ball diameters are determined by spinning speeds.

Kent Displays are based on a kind of a liquid crystal display (LCD), which is called a cholesteric LCD because the liquid crystal material which it uses was derived from actual animal cholesterol. Cholesteric LCD material is sandwiched between two conducting electrodes and can be switched between two stable states—focal conic and planar states. By selectively reflecting different wavelengths, they produce color. Unlike, TN-LCDs used in laptops today, cholesteric LCDs appear bright in bright light just like paper. The pixels can be switched from conic to planar state or back by application of about 20-30V. Since it does not use polarizers and color filters, wide viewing angles and high brightness and contrast are obtained that is claimed to be comparable with newsprint. The display cell acts as a collection of tiny mirrors, each reflecting about 50% of the incident light. The resulting total reflection approaches 40% of the incident light. While it is not as good as paper which reflects at least 80%, compared to other reflective displays, the Ch-LCD does reflects more light than other systems. Its contrast ratio (normally 20 to 1) gets even better when taken out into the sunlight due to its reflective nature. This display is also claimed to show videos as it can be switched within 30 milliseconds.

In other aspects of the invention, methods for modifying, personalizing, individualizing, etc. the appearance of a presentation or transaction instrument of the invention are described. The presentation and transaction instruments of the invention provide the benefit of dynamic image display, which may be modified and updated after manufacture of the presentation or transaction card body. As such, in certain aspects, the invention provides methods for modifying the appearance of a presentation or transaction instrument with graphic image display. While the methods of the invention will generally be described with reference to the embodiments of FIGS. 1A and 1B, it is understood that the methods are not so limited.

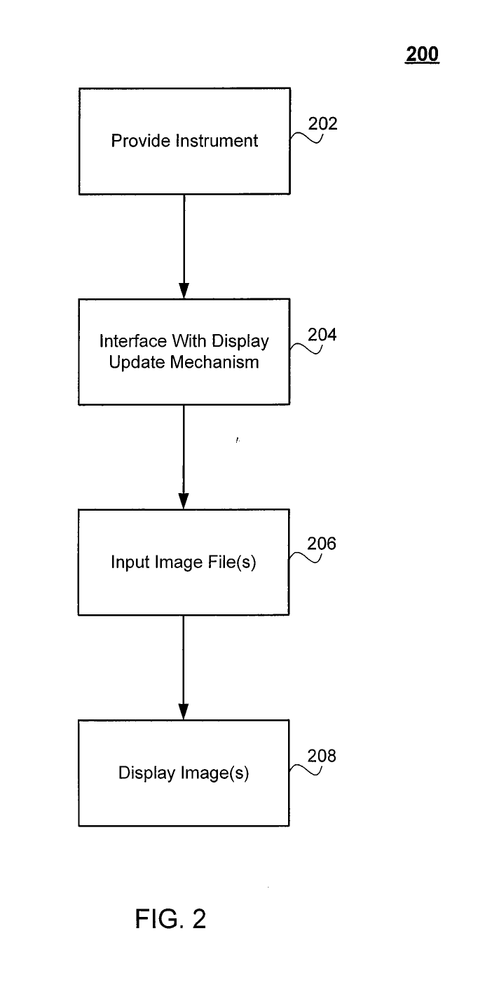

Turning now to FIG. 2, a general method 200 is illustrated, wherein at block 202 a presentation or transaction instrument 100 of the invention with graphic image display capabilities is provided. Any presentation or transaction instrument 100 of the invention may be used in connection with the methods described herein. For instance, the presentation or transaction instrument 100 of the invention may comprises a card body, at least one graphic image display element 110, and a display update mechanism 112. The method then continues to block 204 where the display update mechanism 112 is interfaced with, e.g., via a wired or wireless means, and at block 206 at least one graphic image file is input into the graphic image display element(s) 110.

The interface with the display update mechanism 112 is then disconnected, and the image file(s) displayed via the graphic image display element(s) 110 at block 208. In certain embodiments, the image display element(s) 110 may have an image memory function which allows the elements to display the image file(s) without power requirements once the image file(s) are input for display.

In a particular embodiment, a method of personalizing the visual appearance of a presentation or transaction instrument is provided, the method comprising: providing a presentation or transaction instrument, wherein the presentation or transaction instrument comprises a) a presentation or transaction card body defining a front surface and a back surface, the card body having long term information printed on at least one surface thereof; b) at least one graphic image display element, the at least one graphic image display element being configured to display at least one graphic image file, viewable from at least one side of the presentation or transaction card body; and c) a display update mechanism configured to receive input of the at least one graphic image file from an external file source and to interface with the at least one graphic image display element to provide the graphic image file thereto, to thereby provide for display of the graphic image file; and inputting at least one personalized graphic image file via the display update mechanism for display via the at least one graphic image display element, thereby personalizing the visual appearance of the presentation or transaction instrument.

Again, with regard to the methods of the invention, the graphic image display element(s) may comprises an electro-optic display, such as, but not limited to, a flexible LCD screen, a light emitting polymer (LEP) display, or electronic paper. Further, the electro-optic display may comprise an image memory function that does not require power to maintain temporary display of the graphic image file once implement in the image memory function.

The personalized graphic image file may also be in a file format selected from the group consisting of: JPEG, TIFF, RAW, GIF, and DNG file formats, and may be inputted from an external file source, such as a digital camera, a database, and a personal computer. As such, in such embodiments, the methods may include interfacing (e.g., via wired or wireless means) a digital camera or personal computer to a presentation or transaction instrument of the invention, and inputting a digital photo to the graphic image display element.

As described above, the presentation or transaction instrument may be a stored-value card, credit card, automated teller machine card, calling card, transit card, business card, and promotional card, etc. Thus, the methods of the invention may provide means for personalizing the appearance for such instruments to provide for security, entertainment, etc. For instance, credit cards, ATM cards, etc. may have personal photos of the authorized users uploaded post-manufacture. In other instances, stored-value cards (e.g., gift cards) may have family photos, holiday photos, children's photos, children's drawings, etc. uploaded post-manufacture for personalized gift giving.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A presentation or transaction instrument with graphic image display, comprising:
a) a presentation or transaction card body defining a front surface and a back surface, the card body having long term information printed on at least one surface thereof;
b) at least one graphic image display element, the at least one graphic image display element being configured to display at least one graphic image file, viewable from at least one side of the presentation or transaction card body; and
c) a display update mechanism configured to receive input of the at least one graphic image file from an external file source and to interface with the at least one graphic image display element to provide said graphic image file thereto, to thereby provide for display of said graphic image file.

2. The presentation or transaction instrument of claim 1, further comprising machine readable information selected from the group consisting of: a magnetic stripe on the card body, an embedded memory chip with exposed contacts on the card body, an RFID chip embedded in the card body, bar code information printed on the card body, a key fob, a smart chip, and combinations thereof.

3. The presentation or transaction instrument of claim 1, wherein the at least one graphic image display element comprises an electro-optic display.

4. The presentation or transaction instrument of claim 3, wherein the electro-optic display is selected from the group consisting of a flexible LCD screen, a light emitting polymer (LEP) display, a LED display, a three dimensional hologram and electronic paper.

5. The presentation or transaction instrument of claim 3, wherein the electro-optic display comprises an image memory function that does not require power to maintain temporary display of said at least one graphic image file once implement in the image memory function.

6. The presentation or transaction instrument of claim 1, wherein said at least one graphic image file is in a file format selected from the group consisting of: JPEG, TIFF, RAW, GIF, and DNG file formats.

7. The presentation or transaction instrument of claim 1, wherein said presentation or transaction instrument is selected from the group consisting of: stored-value cards, credit cards, automated teller machine cards, calling cards, transit cards, business cards, and promotional cards.

8. The presentation or transaction instrument of claim 1, wherein said display update mechanism is configured to receive said input of the at least one graphic image file via a wired or wireless communications interface.

9. The presentation or transaction instrument of claim 1, wherein said display update mechanism is configured to receive said input of the at least one graphic image file from an external file source selected from the group consisting of: a digital camera, a database, and a personal computer.

10. A method of personalizing the visual appearance of a presentation or transaction instrument, said method comprising:
providing a presentation or transaction instrument, wherein said presentation or transaction instrument comprises a) a presentation or transaction card body defining a front surface and a back surface, the card body having long term information printed on at least one surface thereof; b) at least one graphic image display element, the at least one graphic image display element being configured to display at least one graphic image file, viewable from at least one side of the presentation or transaction card body; and c) a display update mechanism configured to receive input of the at least one graphic image file from an external file source and to interface with the at least one graphic image display element to provide said graphic image file thereto, to thereby provide for display of said graphic image file;
interfacing with said display update mechanism; and
inputting at least one personalized graphic image file via said display update mechanism for display via said at least one graphic image display element, thereby personalizing the visual appearance of said presentation or transaction instrument.

11. The method of claim 10, wherein the at least one graphic image display element comprises an electro-optic display.

12. The method of claim 11, wherein the electro-optic display is selected from the group consisting of a flexible LCD screen, a light emitting polymer (LEP) display, and electronic paper.

13. The method of claim 11, wherein the electro-optic display comprises an image memory function that does not require power to maintain temporary display of said at least one graphic image file once implement in the image memory function.

14. The method of claim 10, wherein said at least one personalized graphic image file is in a file format selected from the group consisting of: JPEG, TIFF, RAW, GIF, and DNG file formats.

15. The method of claim 10, wherein said presentation or transaction instrument is selected from the group consisting of: stored-value cards, credit cards, automated teller machine cards, calling cards, transit cards, business cards, and promotional cards.

16. The method of claim 10, wherein said at least one personalized graphic image file is inputted via a wired or wireless communications interface.

17. The method of claim 10, wherein said at least one personalized graphic image file is inputted from an external file source selected from the group consisting of: a digital camera, a database, and a personal computer via a USB port.

18. The method of claim 10, wherein said at least one personalized graphic image file is a digital photo.

19. A presentation or transaction instrument with graphic image display, comprising:
a) a presentation or transaction card body defining a front surface and a back surface, the card body having long term information printed on at least one surface thereof;
b) at least one graphic image display element, the at least one graphic image display element being configured to display at least one graphic image file, viewable from at least one side of the presentation or transaction card body; and
c) a display update mechanism configured to receive input of the at least one graphic image file from an external file source and to interface with the at least one graphic image display element to provide said graphic image file thereto, to thereby provide for display of said graphic image file, and wherein the display update mechanism is further configured to receive input of an audio file.
